(19) United States
(12) Patent Application Publication
(10) Pub. No.: US 2006/0020844 A1
(43) Pub. Date: Jan. 26, 2006

(54) Recovery of custom BIOS settings

(76) Inventors: Patrick L. Gibbons, Magnolia, TX (US); Chris E. Pepper, Tomball, TX (US); Paul J. Broyles III, Cypress, TX (US); Mark A. Piwonka, Tomball, TX (US)

Correspondence Address: HEWLETT-PACKARD COMPANY;Intellectual Property Administration, P.O. Box 272400, Fort Collins, CO, 80527-2400, US

(21) Appl. No.: 10/895,962

(22) Filed: Jul. 22, 2004

(51) Int. Cl. G06F 11/00

(52) U.S. Cl. 714/2

(57) ABSTRACT

Embodiments of the invention are directed to recovering custom BIOS settings in a computer having a system ROM, a first non-volatile memory and a second non-volatile memory, comprising: storing custom default BIOS settings in the first memory, wherein custom default BIOS settings comprise at least the custom BIOS settings; and storing current BIOS settings in the second memory, wherein the current BIOS settings comprise at least a copy of the default BIOS settings, wherein an executing BIOS accesses the second memory and not the first memory.

### BACKGROUND

A computer system's basic input/output system (BIOS) is the lowest-level software in the computer, and is among the first code to be loaded and executed by a computer during the boot-up process. The BIOS acts as an interface between system hardware (particularly the chipset and processor) and the operating system. The BIOS is also responsible for allowing a user to control the computer's hardware settings, for booting up the computer when power is applied or the computer is reset, and for performing various other system functions.

Typically, default BIOS settings are stored in system ROM along with the BIOS code. These static settings, which define a standard configuration, are loaded into a non-volatile memory such as a battery-powered CMOS memory device, where they are accessed by the BIOS during the boot-up process. When stored in non-volatile memory, the default BIOS settings become dynamic; that is, they are accessed and can be modified. As such, the BIOS settings that are stored in CMOS memory at any given time are referred to herein as current BIOS settings.

The current BIOS settings stored in non-volatile memory may be customized to support system configurations other than those offered by a computer manufacturer. For example, some current processors can implement a technique known as hyperthreading which allows a single processor to appear to be two processors for certain instructions. However not all computers, even those with hyperthreading processors, are configured to provide this capability. As such, the default BIOS settings typically include a value indicating that hyperthreading is disabled. During construction or use of a computer in which hyperthreading is to be implemented, the current BIOS settings are customized; that is, charged, to include a setting to enable the hyperthreading capability.

At times, the current BIOS settings can become unusable. For example, the current BIOS settings may be inadvertently modified or reset by the user. Or, perhaps, the data stored in the non-volatile memory may be corrupted or the memory itself may fail. Should the current BIOS settings be lost, corrupted or otherwise determined to be inaccurate or unusable (generally referred to herein as “unusable”), the non-volatile memory is unable to supply the current BIOS settings to the BIOS during the boot-up process.

Traditionally, when the current BIOS settings become unusable, the BIOS copies the default BIOS settings from system ROM to non-volatile memory, and thereafter uses that copy of default BIOS settings as the current BIOS settings. Unfortunately, the default BIOS settings do not include the custom settings that were individually set by the computer manufacturer or user. To recover the customized BIOS settings, the user must invoke a BIOS set-up program during the boot-up process and manually re-enter each custom setting. In addition to the inconvenience and risk of error, returning the computer to the desired configuration is often not possible because the custom BIOS settings are unknown to the user and/or not recorded in a separate medium accessible to the user.

### SUMMARY

In one aspect of the invention, a method for recovering custom BIOS settings in a computer having a system ROM, a first non-volatile memory and a second non-volatile memory, is disclosed. The method comprises: storing custom default BIOS settings in the first memory, wherein custom default BIOS settings comprise at least the custom BIOS settings; and storing current BIOS settings in the second memory, wherein the current BIOS settings comprise at least a copy of the default BIOS settings, wherein an executing BIOS accesses the second memory and not the first memory.

In another aspect of the invention, a computer is provided, comprising: a read only memory accessible to a processor of the computer and having stored therein BIOS code and static default BIOS settings; a BIOS-accessible non-volatile memory in which is stored current BIOS settings comprising at least a copy of the default BIOS settings and user BIOS settings, if any; a BIOS-inaccessible non-volatile memory in which is stored custom BIOS settings; and a BIOS recovery module configured to copy or move at least a portion of the BIOS settings from the BIOS-inaccessible to the BIOS-accessible memory in response to a recovery condition.

### BRIEF DESCRIPTION OF THE DRAWINGS

FIG. 1A is a block diagram of an exemplary computer in which embodiments of the present invention may be implemented.

FIG. 1B is a logical block diagram of the system ROM shown in FIG. 1A.

FIG. 2A is a functional block diagram illustrating the flow of data implemented in an embodiment of the present invention to store and to automatically recover custom BIOS settings in a computer.

FIG. 2B is a functional block diagram illustrating the flow of data implemented in an embodiment of the present invention to store and to automatically recover custom BIOS settings in a computer.

FIG. 2C is a functional block diagram illustrating the flow of data implemented in an embodiment of the present invention to store and to automatically recover custom BIOS settings in a computer.

FIG. 2D is a functional block diagram illustrating the flow of data implemented in an embodiment of the present invention to store and to automatically recover custom BIOS settings in a computer.

FIG. 3A is a flow chart of one embodiment of the operations performed in the an embodiment illustrated in FIG. 2A to separately store custom BIOS default settings and current BIOS settings.

FIG. 3B is a high-level flow chart of the operations performed to automatically recover custom BIOS settings.

FIG. 4 is a high-level flow chart of one embodiment of the present invention for recovering custom BIOS settings in a computer having a system ROM, a first non-volatile memory and a second non-volatile memory.

### DETAILED DESCRIPTION

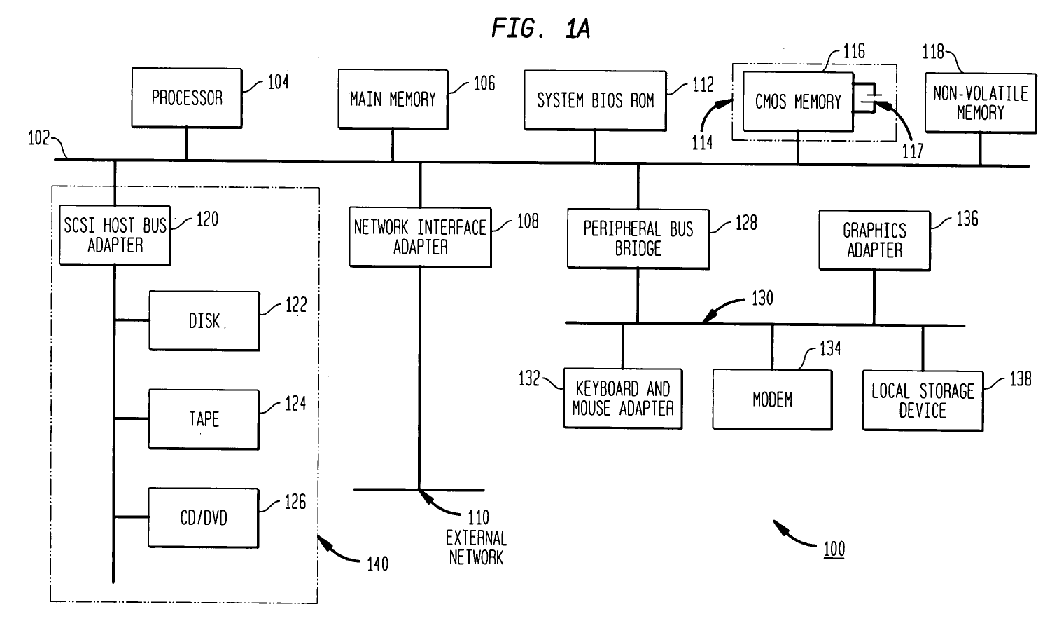

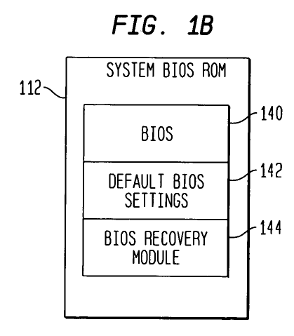

FIG. 1A is a block diagram of an exemplary computer 100 in which embodiments of the present invention may be implemented. In particular, computer 100 comprises a processor 104 and main memory 106 coupled via a system bus 102. System bus 102 may implement a PCI local bus architecture, although other bus architectures such as Industry Standard Association (ISA) or Accelerated Graphics Port (AGP) bus architectures may be employed. System bus 102 provides an interface for processor 104 to several other components in computer 100. These components may include, for example, a network interface adapter 108 that connects system bus 102 to an external network 110, and a SCSI memory system 140. Memory system 140 comprises a host adapter 120 and a number of devices implementing different media, such as a disk drive 122, tape drive 124, and a CD ROM 126. In addition, computer 100 comprises a peripheral bus bridge 128 that connects peripheral bus 130 with system bus 102. Peripheral bus 130 provides an interface for such devices as a keyboard and mouse adapter 132, modem 134, local storage device 138 and graphics adapter 136. Local storage device 138 is a non-volatile memory device such as a flash-memory, floppy disk drive, CD drive, or other persistent electronic, magnetic, or optical drive.

An operating system, such as Windows XP available from Microsoft Corporation, runs on processor 104 and is used to coordinate and control various applications, peripherals, and other components within computer 100. Typically, the operating system and application programs are located on storage devices such as hard disk 122 and local storage device 138, and are loaded into main memory 106 for execution by processor 104.

It should be apparent that computer 100 as described above may be configured differently depending on the type of computer and the application(s) for which the computer is to be used. For instance, other internal hardware or peripheral devices may be used in addition to, or in place of, the components depicted in FIG. 1A. For example, if computer 100 is configured as a network computer, it may not include a SCSI host bus adapter 120, hard drive 122, tape drive 124, and CD drive 126 as depicted by dotted line 140 denoting optional inclusion. Computer 100 may also be a stand alone computer, e.g., a desktop computer, workstation, blade system or laptop computer. Furthermore, computer 100 may be a personal digital assistant (PDA) that is configured with ROM and flash-memory to provide non-volatile storage of operating system files, application files, and user generated data. In any configuration, computer 100 depicted in FIG. 1A and described herein, is not meant to limit applicable embodiments of the invention to a particular computer architecture.

Computer system 100 also comprises a system basic input/output system (BIOS) ROM 112 accessible to processor 104 via system bus 102. System ROM 112 is typically implemented as an electrically-erasable read-only memory (EEPROM) chip, commonly referred to as a flash BIOS, which can be updated through software control. Generally, system ROM 112 is located in a socket on the motherboard (not shown) of computer 100, as is customary, although not all embodiments of computer system 100 have such a configuration.

FIG. 1B is a logical block diagram illustrating data which may be stored in system BIOS ROM 112. System BIOS ROM 112 is the main hardware component of the system BIOS and, in the embodiment shown in FIG. 1B, stores BIOS 140, default BIOS settings 142 and a BIOS recovery module 144.

BIOS settings are the values used by BIOS 140 to set hardware and software configurations of computer 100 during the boot-up process. Default BIOS settings 142, which define a default or standard hardware configuration, are typically provided by the BIOS manufacturer and are permanently stored in system BIOS ROM 112. Typically, these values can not be overwritten nor can they be modified. Accordingly, default BIOS settings are sometimes referred to as static default BIOS settings 142.

A non-volatile memory (NVRAM) 114 is also included in computer 100 to store the BIOS settings in a memory device from which they can be retrieved by BIOS 140 during the boot-up process, and where they can be modified to support system configurations other than the default or standard hardware configuration offered by a computer manufacturer. Commonly, a special type of NVRAM is used to store such data, referred to as CMOS memory. CMOS (Complementary Metal Oxide Semiconductor) is a type of technology used to make integrated circuits which require very little power. A very small dedicated battery 117 is used to trickle a small charge to CMOS 116 to ensure the data it stores is preserved with loss or interruption of system power. CMOS memory devices are often quite small, commonly 64 bytes, and the batteries 117 that they use typically last for years.

In addition, a non-volatile memory 118 is included in computer system 100 to support operations of certain embodiments of the present invention as described in detail below. As one of ordinary skill in the art would appreciate, non-volatile memory 118 may be a disk system such as a floppy, hard disk, optical or magnetic/optical disk, a persistent RAM, flash RAM or ROM, or a form of erasable and writeable ROM, e.g., E2PROM. Other types of non-volatile memory now or later developed may be used depending on the system requirements.

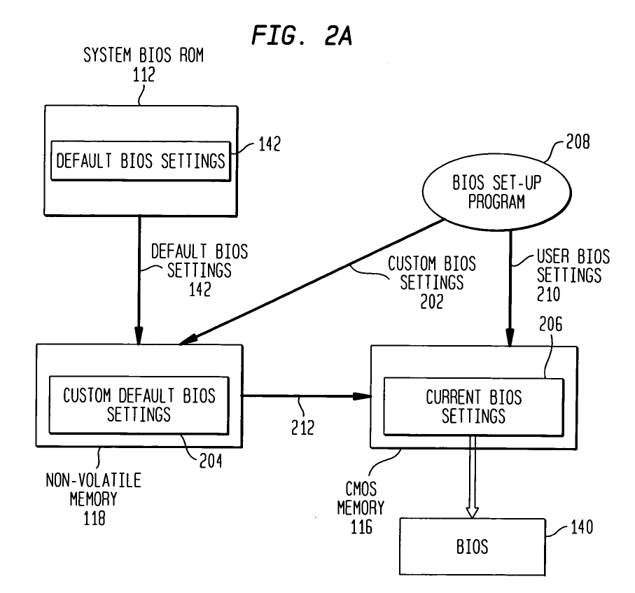

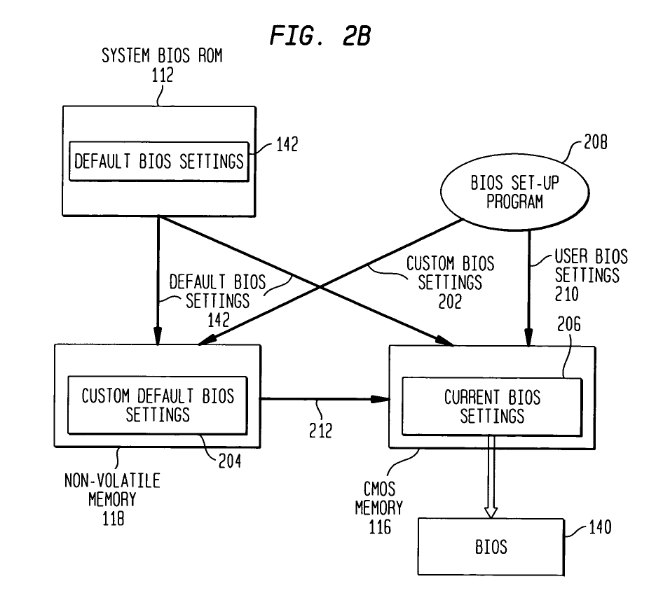

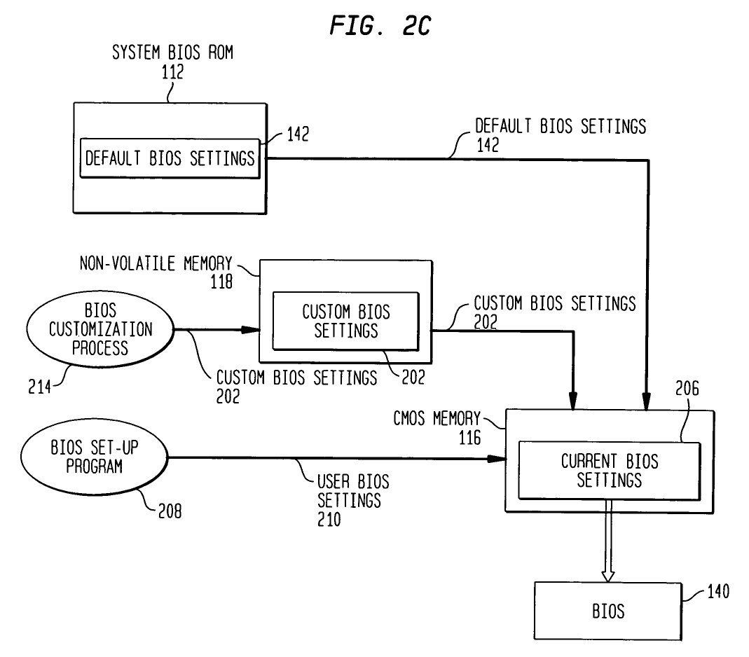

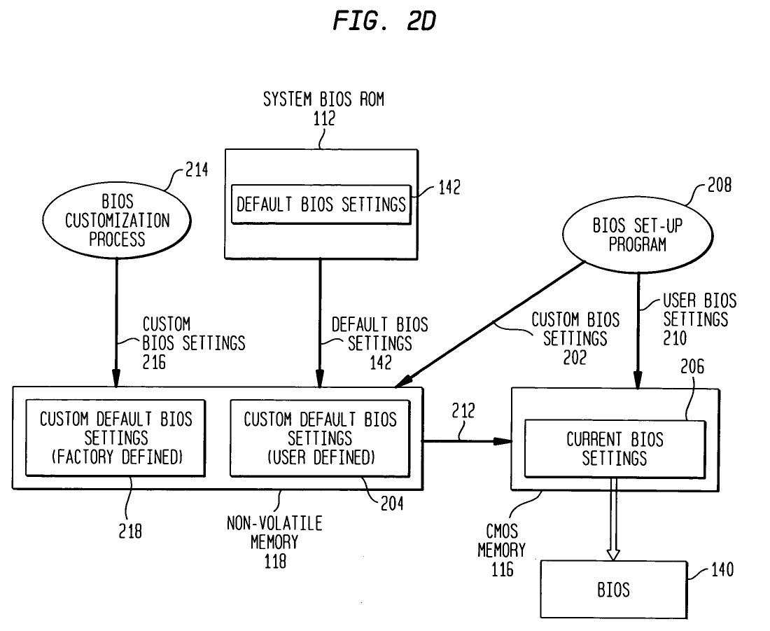

FIG. 2A is an interface block diagram illustrating the flow of data implemented in one embodiment of the invention to store and automatically recover custom BIOS settings in computer 100. In FIG. 2A three memory devices introduced in FIG. 1A are shown: system ROM 112, non-volatile memory 118 and CMOS memory 116. System ROM 112 has stored therein static default BIOS settings 142. As noted, default BIOS settings 142 define a default or standard hardware configuration, and are typically provided by the BIOS manufacturer. Typically, default BIOS settings 142 are permanently stored in system ROM 112 and can not be overwritten nor can they be modified.

Non-volatile memory 118 has stored therein custom default BIOS settings 204. As noted, non-volatile memory device 118 is not directly accessible by BIOS 140. In the embodiment shown in FIG. 2A, non-volatile memory 118 receives default BIOS settings 142 from system ROM 112. If default BIOS settings 142 are to be customized by the user, system manufacturer or otherwise, such custom BIOS settings 202 are also stored in non-volatile memory 118. Custom BIOS settings 202 may be set by the manufacturer through various mechanisms such as diagnostic tools, software images, customization tool, and the like. Custom BIOS settings 202 may also be provided by the user via, for example, BIOS set-up program 208, as shown in the exemplary embodiment of FIG. 2A.

When custom BIOS settings 202 are written to non-volatile memory 118, the settings may be written over the corresponding default BIOS settings 142. Alternatively, default BIOS settings 142 can be maintained in their original state in non-volatile memory 118 and custom BIOS settings 202 would then be stored is separate memory locations in non-volatile memory 118. Regardless of the approach taken, custom default BIOS default settings 204 which are stored in non-volatile memory 118 comprise default BIOS settings 142 and custom BIOS settings 202, if any. As noted, custom default BIOS settings 204 stored in non-volatile memory 118 are not provided directly to BIOS 140 or otherwise utilized unless the current BIOS settings 206 stored in CMOS memory 116 are to be recovered.

CMOS memory 116 has stored therein current BIOS settings 206. Current BIOS settings 206 comprise default BIOS settings 142 as modified by user BIOS settings 210. In the examplary embodiment shown in FIG. 2A, CMOS memory 116 receives custom default BIOS settings 204 from non-volatile memory 118, as depicted by arrow 212, to form current BIOS settings 206. Current BIOS settings 206 may be updated with user BIOS settings 210 provided, in this example, via a BIOS set-up program 208. BIOS set-up program 208 is invoked by the user, for example, by pressing the F10 key on the computer keyboard (not shown) during the boot-up sequence. It should be appreciated by those of ordinary skill in the art that the manner in which BIOS setup programs are invoked is typically dictated by the manufacturer of BIOS 140. It should also be appreciated that user BIOS settings 210 can be generated using other techniques and mechanisms now or later developed.

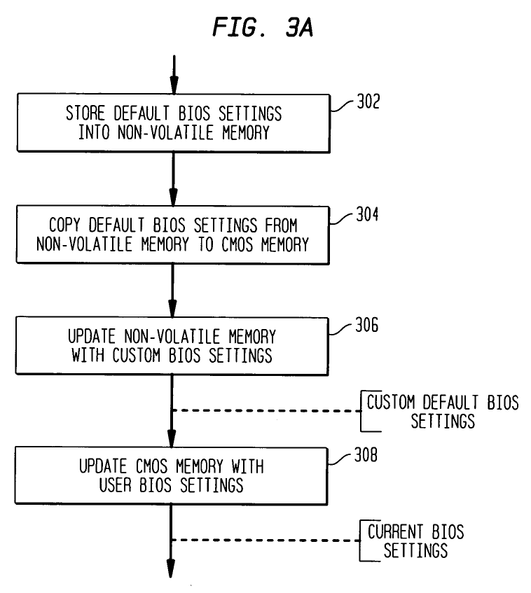

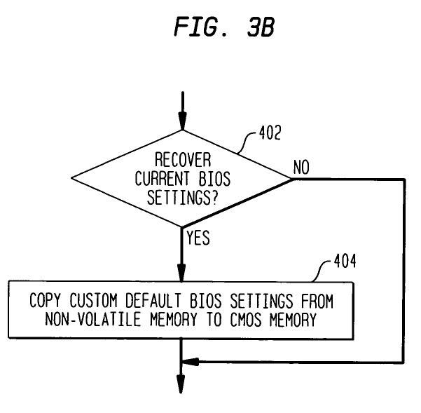

A flow chart of one embodiment of the operations performed to generate custom BIOS default settings 204 and current BIOS settings 206 in the arrangement shown in FIG. 2A, is shown in FIG. 3A.

At block 302 default BIOS settings 142 are stored in memory locations within nonvolatile memory 118. At block 304, the default BIOS settings 142 are copied from non-volatile memory 118 to CMOS memory 116, as shown by arrow 212 in FIG. 2A. As one of ordinary skill in the art would appreciate, default BIOS settings 142 may initially be stored in non-volatile memory 118 and copied to non-volatile memory 116, as noted above, or may be initially stored in CMOS memory 116 and copied to non-volatile memory 118.

At block 306 custom BIOS settings 202 may be written to non-volatile memory 118 to form custom default BIOS settings 204. As noted, custom BIOS settings 202 can be stored in place of or in addition to corresponding default BIOS settings 142, and may be provided, for example, by the factory, purchaser or end-user. Upon completion of the operations depicted at block 306, non-volatile memory 118 has stored therein custom default BIOS settings 204.

At block 308, default BIOS settings 142 stored in CMOS memory 116 may be modified with user BIOS settings 210. In the embodiment shown in FIG. 2A, BIOS set-up program 208 is used to provide user BIOS settings 210. Upon the completion of the operations depicted at block 308, CMOS memory 116 has stored therein current BIOS settings 206. Once current BIOS settings 206 are stored in non-volatile memory 116, they can thereafter be retrieved by BIOS 140. As noted, BIOS 140 accesses CMOS memory 116 to retrieve current BIOS settings 206 during the boot-up process.

In one embodiment, custom BIOS default settings 204 rather than default BIOS settings 142 are copied from non-volatile memory 118 to CMOS memory 116; that is, the copy operations performed at block 304 are performed after the operations depicted in block 306. The manner in which default BIOS settings 142 are copied can vary. For example, default BIOS settings 142 can be copied separately from custom BIOS settings 202. In another embodiment, both default BIOS settings 142 and custom BIOS settings 202 are copied at the same time, for example, at the end of the boot-up process. Other alternatives should be apparent to those of ordinary skill in the art. In such an embodiment the user may then add user BIOS settings 210 to custom default BIOS settings 204 stored in CMOS memory device 116.

In the exemplary embodiment shown in FIG. 2A, custom BIOS settings 202 and user BIO settings 210 are generated by the same process, BIOS set-up program 208. It should be appreciated, however, that custom BIOS settings 202 and user BIOS settings 210 need not be generated by the same process or at the same time. It should also be appreciated that since custom BIOS default settings 204 and current BIOS settings 206 are separately generated, such BIOS settings may not be the same; that is, custom BIOS settings 202 and user BIOS settings 210 may diverge over time. This enables an organization to customize the BIOS settings on a number of computers 100 by providing custom default BIOS settings 204, while enabling a user, department or other group to further modify the BIOS settings of a subset of such computers 100 by modifying current BIOS settings 206 with user BIOS settings 210.

During the boot-up process, BIOS recovery module 144 checks current BIOS settings 206 stored in CMOS memory 116 to determine whether the settings are usable. Current BIOS settings 206 can become unusable due to, for example, data corruption, memory failure, etc. Such verification may be performed in a variety of ways. For example, known memory testing techniques may be used. Alternatively, BIOS recovery module 144 may monitor system reset and other conditions in computer 100 which may indicate that CMOS memory 116 may be lost or corrupted. As one of ordinary skill in the art would appreciate, other techniques now or later developed can be implemented to determine whether dynamic version 204 of current BIOS settings is unusable.

Should accessible version 206 of the current BIOS settings become unusable, BIOS recovery module 144 automatically recovers custom BIOS settings 202 by copying custom default BIOS settings 204 from non-volatile memory 118 to CMOS memory 116, thereby forming a new version of current BIOS settings 206. Since custom default BIOS settings 204 include both default BIOS settings 142 and custom BIOS settings 202, recovery of custom default BIOS settings 204 eliminates the need for the reentry of custom BIOS settings 202 as part of the recovery process. As one of ordinary skill in the art would appreciate, such recovery operations may also be performed in response to conditions other that the determination that current BIOS settings 206 are unusable. For example, a user may invoke the recovery process through activation of a hardware or software switch. In either such embodiment, however, once the recovery process begins custom BIOS settings 202 are automatically recovered by virtue of their being stored in non-volatile memory 118.

FIG. 3B is a high-level flow chart of the operations performed to automatically recover custom BIOS settings 202 in the exemplary arrangement shown in FIG. 2B. At block 310 a determination is made regarding whether the recover process should be performed. The recovery process can be performed, for example, when the computer system is being booted and the current BIOS default settings are found to be unusable, or may be purposefully invoked, as noted above. In one particular embodiment, during the boot-up process, CMOS memory 116 is examined to make such a determination. It should be understood that CMOS memory 116 can be examined at other times in alternative embodiments of the present invention.

If custom BIOS settings 202 are to be recovered, then the operations at block 312 are performed. At block 312, current BIOS settings 206 stored in CMOS memory 116 are replaced with custom default BIOS settings 204 stored in non-volatile memory 118. Preferably, custom default BIOS settings 204 are copied, although the settings can be moved, from non-volatile memory 118 to CMOS memory 116. Upon the completion of the operations depicted in block 404, a recovered version of current BIOS settings 206 is stored in non-volatile memory 116.

Thus, in the exemplary application noted above in which an organization provides custom BIOS settings 202 while a user may modify current BIOS settings 206, recovery of current BIOS settings 206 does not result in the loss of custom BIOS settings 202. Should the user have modified current BIOS settings 206 by providing user BIOS settings 210, then after recovery of custom default BIOS settings 204, the user may thereafter reenter user BIOS settings 210 to configure the particular computer 100 as desired.

FIG. 2B is a functional block diagram illustrating the flow of data implemented in an alternative embodiment of the present invention to store and automatically to recover custom BIOS settings 202 in a computer. Here, default BIOS settings 142 are copied from system ROM 112 directly to both, non-volatile memory 118 and CMOS memory 116. When custom BIOS settings 202 are generated, using the same example of a BIOS set-up program 208, the custom BIOS settings are provided to non-volatile memory 118 to establish custom default BIOS settings 204 in non-volatile memory 118. Custom default BIOS settings 204 are copied to CMOS memory 116 and updated with user BIOS settings 210, if any, as noted above, to establish current BIOS settings 206 in CMOS memory 1116. Current BIOS settings 206 are thereafter available for BIOS 140. Should current BIOS settings 206 need to be recovered, custom default BIOS settings 204 are copied again from non-volatile memory 118 to CMOS memory 116, as indicated by arrow 212.

FIG. 2C is a functional block diagram of an alternative embodiment of the present invention. Here, default BIOS settings 142 are copied from system ROM 112 directly to non-volatile memory 116, and are not stored in CMOS memory 118. On the other hand, custom BIOS settings 202 are stored in non-volatile memory 118. In the embodiment shown in FIG. 2C, custom BIOS settings 202 are generated by a customization process 214.

To provide current BIOS settings 206 in CMOS memory 116, default BIOS settings 142 are copied from system ROM 112 to CMOS memory 116, and custom BIOS settings 202 are copied from non-volatile memory 118 to CMOS memory 116. In those embodiments in which custom BIOS settings 202 replace corresponding settings in default BIOS settings 142, it is preferable to first copy default BIOS settings 142 into CMOS memory 116 followed by custom BIOS settings 202. Then, user BIOS settings 210, if any, are provided by BIOS set-up program 208. Thus, in this embodiment, CMOS memory 116 has stored therein current BIOS settings 206 while non-volatile memory 118 has stored therein custom BIOS settings 202.

In this embodiment, similar operations are performed to recover custom BIOS settings 202. Should current BIOS settings 206 stored in CMOS memory 116 become unusable, for example, BIOS recovery module 144 retrieves default BIOS settings 142 from system ROM 112 and custom BIOS settings 202 from non-volatile memory 118, and stores the retrieved settings in non-volatile memory 116 in a manner similar to that described above. Thereafter, the user can add user BIOS settings 210 as desired.

FIG. 2D is a functional block diagram of an alternative embodiment of the present invention. Here, two versions of custom default BIOS settings are stored in non-volatile memory 118: factory-defined custom default BIOS settings 218 and user-defined custom default BIOS settings 204. Factory-defined custom default BIOS settings 218 comprise default BIOS settings 142 as modified with custom BIOS settings 216 provided, for example, by a factory BIOS program 214. User-defined custom default BIOS settings 204 comprise default BIOS settings 142 as modified by the user's custom BIOS settings 202, as described above. In this embodiment, either custom default BIOS settings 204, 218 may be copied to CMOS memory 116 for use as part of current BIOS settings 206. In addition, either custom default BIOS settings 204, 218 may be designated to be that which is used to recover current BIOS settings 206.

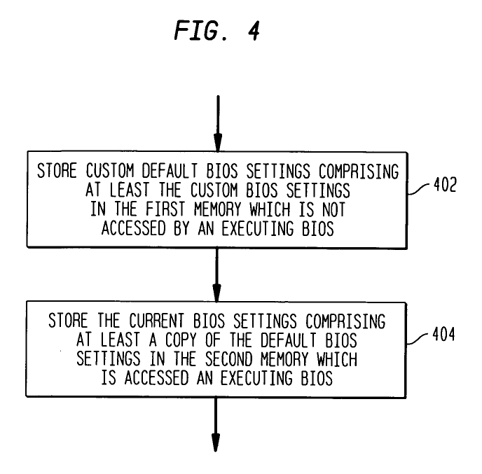

FIG. 4 is a high-level flow chart of one embodiment of the present invention for recovering custom BIOS settings in a computer having a system ROM, a first non-volatile memory and a second non-volatile memory. At block 402, custom default BIOS settings which comprise at least the custom BIOS settings are stored in the first memory which is not accessed by an executing BIOS. At block 404, the current BIOS settings comprising at least a copy of the default BIOS settings are stored in the second memory which is accessed an executing BIOS.

What is claimed is:

1. A method for recovering custom BIOS settings in a computer having a system ROM, a first non-volatile memory and a second non-volatile memory, comprising:
storing custom default BIOS settings in the first memory, wherein custom default BIOS settings comprise at least the custom BIOS settings; and
storing current BIOS settings in the second memory, wherein the current BIOS settings comprise at least a copy of the default BIOS settings,
wherein an executing BIOS accesses the second memory and not the first memory.

2. The method of claim 1, wherein storing custom default BIOS settings in the first memory comprises:
storing a copy of the default BIOS settings into the first memory; and
storing the custom BIOS settings in the first memory.

3. The method of claim 1, wherein storing current BIOS settings in the second memory comprises:
storing the copy of the default BIOS settings in the second memory; and
storing user BIOS settings in the second memory.

4. The method of claim 1, wherein storing current BIOS settings in the second memory comprises:
storing a copy of the custom default BIOS settings in the second memory; and
storing user BIOS settings in the second memory.

5. The method of claim 2, wherein storing the custom BIOS settings in the first memory comprises:
overwriting at least one default BIOS setting with a corresponding custom BIOS setting.

6. The method of claim 2, wherein storing the custom BIOS settings in the first memory comprises:
storing the at least one custom BIOS setting into a location of the first memory in which the default BIOS settings are not stored.

7. The method of claim 1, further comprising:
receiving an indication that the current BIOS settings are to be recovered; and
copying at least a portion of the BIOS settings from the first memory to the second memory in response to receiving the indication.

8. The method of claim 7, wherein receiving an indication that the current BIOS settings are to be recovered; and
receiving an indication that the current BIOS settings are unusable; and

9. The method of claim 7, wherein receiving an indication that the current BIOS settings are to be recovered; and
receiving an indication that recovery has been invoked by a user.

10. The method of claim 1, wherein the first memory comprises a flash memory.

11. The method of claim 1, wherein the second memory comprises a Complementary Metal Oxide Semiconductor (CMOS) memory device powered by a dedicated battery.

12. The method of claim 1, wherein the system ROM comprises an electrically-erasable read-only memory (EEPROM).

13. A computer comprising:
a read only memory accessible to a processor of the computer and having stored therein a BIOS code and static default BIOS settings;
a BIOS-accessible non-volatile memory in which is stored current BIOS settings comprising at least a copy of the default BIOS settings and user BIOS settings, if any;
a BIOS-inaccessible non-volatile memory in which is stored custom BIOS settings; and
a BIOS recovery module configured to copy or move at least a portion of the BIOS settings from the BIOS-inaccessible to the BIOS-accessible memory in response to a recovery condition.

14. The computer of claim 13, wherein the BIOS-inaccessible memory further has stored therein a copy of the default BIOS settings to form with the custom BIOS settings current default BIOS settings.

15. The computer of claim 13, wherein the BIOS-accessible memory further has stored therein a copy of the custom BIOS settings as modified by the user BIOS settings, if any.

16. The computer of claim 13, wherein the recovery condition comprises a determination that at least a portion of the current BIOS settings stored in the BIOS-accessible memory is at least potentially unusable.

17. The computer of claim 13, wherein the recovery condition comprises an invocation of the recovery process.

18. The computer of claim 15, wherein when the custom BIOS settings are stored in the BIOS-inaccessible memory, the custom BIOS settings are written over the corresponding default BIOS settings.

19. The computer of claim 15, wherein the custom BIOS settings are stored in the BIOS-inaccessible memory by a BIOS set-up program.

20. The computer of claim 13, wherein the BIOS recovery module is configured to copy or move the custom default BIOS settings from the BIOS-inaccessible to the BIOS-accessible memory during a boot-up process.

21. The computer of claim 13, wherein the BIOS-accessible memory comprises a Complementary Metal Oxide Semiconductor (CMOS) memory device powered by a dedicated battery.

22. The computer of claim 13, wherein the default BIOS settings are permanently stored in the ROM.

23. The computer of claim 13, wherein the system ROM comprises an electrically-erasable read-only memory (EEPROM).

24. A computer readable medium on which is embedded a program, the program performing a method for recovering custom BIOS settings in a computer having a system ROM, a first non-volatile memory and a second non-volatile memory, comprising:
storing custom default BIOS settings in the first memory, wherein custom default BIOS settings comprise at least the custom BIOS settings; and
storing current BIOS settings in the second memory, wherein the current BIOS settings comprise at least a copy of the default BIOS settings,
wherein an executing BIOS accesses the second memory and not the first memory.

25. The computer readable medium of claim 24, wherein storing custom default BIOS settings in the first memory comprises:
storing a copy of the default BIOS settings into the first memory; and
storing the custom BIOS settings in the first memory.

26. The computer readable medium of claim 24, wherein storing current BIOS settings in the second memory comprises:
storing the copy of the default BIOS settings in the second memory; and
storing user BIOS settings in the second memory.

27. The computer readable medium of claim 24, wherein storing current BIOS settings in the second memory comprises:
storing a copy of the custom default BIOS settings in the second memory; and
storing user BIOS settings in the second memory.

28. The computer readable medium of claim 24, further comprising:
receiving an indication that the current BIOS settings are to be recovered; and
copying at least a portion of the BIOS settings from the first memory to the second memory in response to receiving the indication.

29. A computer comprising:
means for storing in a read only memory accessible to a processor of the computer a BIOS code and static default BIOS settings;
means for storing in a BIOS-accessible non-volatile memory current BIOS settings comprising at least a copy of the default BIOS settings and user BIOS settings, if any;
means for storing in a BIOS-inaccessible non-volatile memory custom BIOS settings; and
means for transferring at least a portion of the BIOS settings from the BIOS-inaccessible to the BIOS-accessible memory in response to a recovery condition.

30. The computer of claim 29, further comprising:
means for storing in the BIOS-inaccessible memory a copy of the default BIOS settings to form, with the custom BIOS settings, current default BIOS settings.

31. The computer of claim 29, further comprising:
means for storing in the BIOS-accessible memory a copy of the custom BIOS settings as modified by the user BIOS settings, if any.

32. The computer of claim 29, wherein the recovery condition comprises a determination that at least a portion of the current BIOS settings stored in the BIOS-accessible memory is at least potentially unusable.
